(19) United States
(12) Patent Application Publication
(10) Pub. No.: US 2009/0267523 A1
(43) Pub. Date: Oct. 29, 2009

(54) DRIVER CIRCUIT FOR LIGHT SHEET MODULE WITH DIRECT CONNECTION TO POWER SOURCE

(75) Inventor: Ray Phillips, Portland, CT (US)

Correspondence Address: MICHAUD-DUFFY GROUP LLP, 306 INDUSTRIAL PARK ROAD, SUITE 206, MIDDLETOWN, CT, 06457, US

(73) Assignee: Articulated Technologies, LLC, Wallingford, CT (US)

(21) Appl. No.: 12/428,709

(22) Filed: Apr. 23, 2009

Related U.S. Application Data
(60) Provisional application No. 61/047,473, filed on Apr. 24, 2008.
(60) Provisional application No. 61/047,588, filed on Apr. 24, 2008.

(51) Int. Cl. H05B 37/02

(52) U.S. Cl. 315/152; 315/250

(57) ABSTRACT

A light sheet module includes a light sheet having LEDs on a substrate and a driver circuit for the LEDs. The driver circuit includes a first control loop and a second control loop. The first loop contains TRIACS for regulating current from an external AC power source to the LEDs in response to trigger signals. A constant current circuit receives a command signal indicative of a target current in the LEDs, and generates the trigger signals. Current feedback circuitry generates a current feedback signal indicative of the actual current in the LEDs. The constant current circuit responds to the current feedback circuitry and adjusts the trigger signals so that the actual current in the LEDs more closely approaches the target current. The second control loop contains a Driver controller that generates the command signal and that is responsive to an input device for the Driver controller.

### CROSS-REFERENCE TO RELATED APPLICATIONS

This application claims the benefit of U.S. Provisional Application No. 61/047,473, filed Apr. 24, 2008, and of U.S. Provisional Application No. 61/047,588, filed Apr. 24, 2008; both of which are hereby incorporated herein by reference, in their entirety.

### FIELD OF THE INVENTION

This invention relates to LED (light-emitting diode) light sheets, and in particular to driver circuits for LED light sheets used for backlighting digital displays. This invention also relates to LED (light-emitting diode) light sheets, and in particular to driver circuits for LED light sheets used for backlighting digital displays.

### BACKGROUND

Backlighting is used for illumination of liquid crystal displays (LCDs) to increase readability or image quality in computer displays, LCD televisions and other devices. One possible implementation of a backlight includes red, green and blue light-emitting diodes (LEDs) in order to produce white light for use with LCD televisions and monitors. However, a backlight device that provides an unchanging output or that cannot adjust to operating conditions does not facilitate optimum viewing of the display at all times. In addition, large format backlight units require that the LEDs be driven from a high wattage DC power source to get the desired brightness. Still, it is normally necessary to modulate the power supplied to an LCD device from a standard alternating current (AC) power supply by providing complicated power supply circuitry between the standard AC power supply and the driver circuit for the LEDs in the backlight sheet, adding to the expense and complexity of manufacturing the backlight sheet.

### SUMMARY OF THE INVENTION

The present invention resides in one aspect in a light sheet module that includes a light sheet having separately controllable pluralities of LEDs on a substrate and a driver circuit for the LEDs, the driver circuit including a first control loop and a second control loop. The first control loop contains TRIACS for regulating current from an external AC power source to the separately controllable pluralities of LEDs in response to trigger signals. There is also a constant current circuit for receiving a command signal indicative of a target current in the separately controllable pluralities of LEDs and for generating trigger signals to cause the TRIACs to provide current to the separately controllable pluralities of LEDs from the external AC power source. In addition, there is current feedback circuitry for generating a current feedback signal indicative of the actual current in the separately controllable pluralities of LEDs, the constant current circuit being responsive to the current feedback circuitry to adjust the trigger signals so that the actual current in the separately controllable pluralities of LEDs more closely approaches the target current. The second control loop contains a driver controller configured to generate the command signal for the constant current circuit and being responsive to at least one input device for the driver controller.

In another aspect, the present invention provides a backlight unit that is comprised of several light sheet modules. The light sheet modules include a substrate, top ITO layer associated electronics and pluralities LEDs that can produce white light together.

In yet another aspect, the present invention provides a method for powering a light sheet that contains separately controllable pluralities of LEDs, by providing a TRIAC connected between an external AC power source and each separately controllable plurality of LEDs and providing trigger signals to each TRIAC to modulate the flow of current from the external AC power source through each TRIAC to the respective separately controllable plurality of LEDs to attain a target current through, and resulting output from, each respective separately controllable plurality of LEDs.

According to another aspect of the invention, the first control loop may include the LEDs, a continuous mode inductor converter (CMIC) for the LEDs and current feedback circuitry. The CMIC provides current to the LEDs at a level indicated by the modulation signal as being a target current, and the current feedback circuitry provides a feedback signal that indicates the actual level of current in the LEDs. The CMIC is responsive to the feedback signal to adjust the current to the LEDs to more closely approach the target current indicated by the modulation signal.

Another aspect of the invention provides that the second control loop may include a processor and a light sensor. The processor generates the modulation signal, while the light sensor provides a signal that indicates the intensity of the output of the LEDs. The processor is responsive to the light sensor and adjusts the modulation signal to adjust the output of the LEDs to a predetermined level.

Still another aspect of the invention provides a driver circuit wherein the second control loop includes a processor that generates the modulation signal, and an ambient light detector. The ambient light detector is configured to provide a signal that indicates the intensity of ambient light, and the processor is responsive to the ambient light detector sensor and adjusts the modulation signal to adjust the output of the LEDs to a predetermined level in relation to the intensity of the ambient light.

In yet another embodiment, the second control loop includes a processor that generates the modulation signal, a temperature sensor and a mapped data table. The temperature sensor provides a signal that indicates the temperature of the LEDs, and the mapped data table contains data relating the LED temperature to desired LED current. The processor is responsive to the temperature sensor and to the mapped data table and adjusts the modulation signal to adjust the current to the LEDs to a predetermined level in relation to the temperature of the LEDs.

In various embodiments, the second control loop includes circuitry to generate the modulation signal using a time averaging technique or a pulse width modulation technique.

The light sheet module may include a plurality of LEDs, there may be a driver circuit and conductive trace layer for each LED. The processor may determine a modulation signal for each of the LEDs in the light sheet module.

### BRIEF DESCRIPTION OF THE DRAWINGS

FIG. 1 is a schematic diagram of a light sheet module and driver circuit according to a first embodiment of this invention; and

FIG. 2 is a schematic diagram of a light sheet module and driver circuit according to another embodiment of this invention.

### DETAILED DESCRIPTION OF THE INVENTION

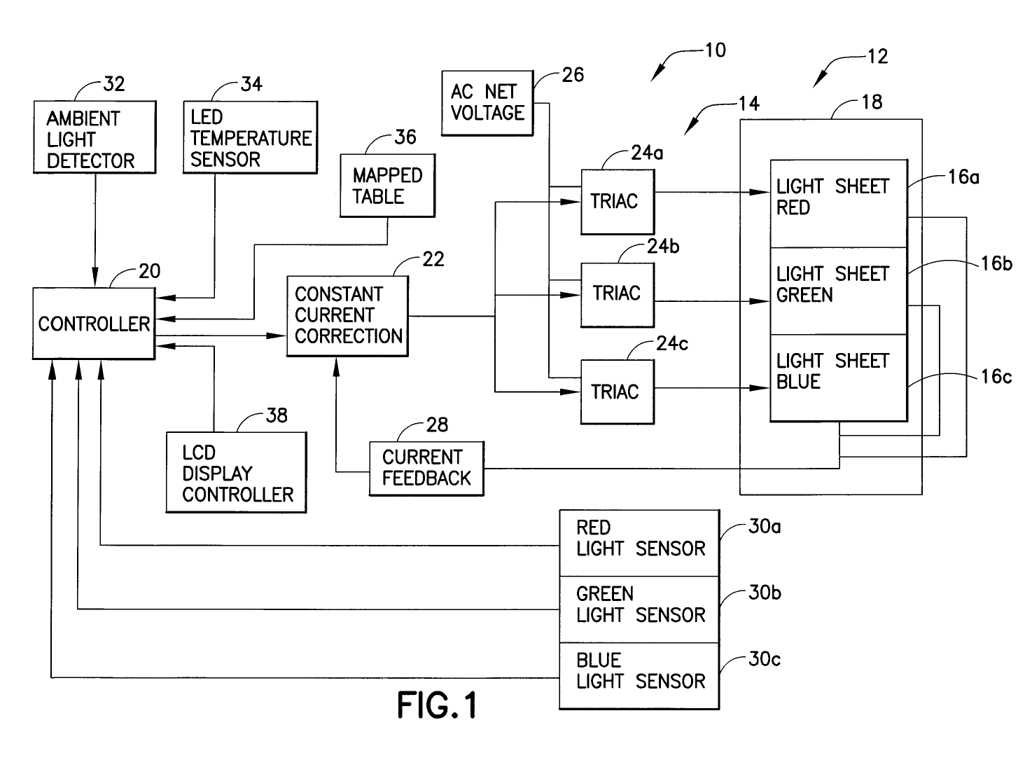

A light sheet module indicated generally by the reference numeral 10 in FIG. 1 contains a light sheet 12 and a driver circuit 14 connected to the light sheet. The light sheet 12 includes strings (i.e., series-connected) of red, green and blue light-emitting diodes (LEDs) 16a, 16b and 16c that are disposed on a light sheet substrate 18 as described further hereinbelow. Each LED string 16a, 16b and 16c comprises a plurality of like-colored red, green, or blue LEDs, and each LED string 16a, 16b and 16c is controllable separately from the others, i.e., the current through one LED string 16a, 16b or 16c is not dependent on current through another LED string. The driver circuit 14 is mounted on a driver circuit substrate (not shown) that is separate from the light sheet substrate 18, and the driver circuit is connected to the LED strings 16a, 16b and 16c in any convenient manner, e.g., by a modular connector (not shown). However, this is not a limitation on the invention, and in other embodiments, the driver circuit 14 (or some part thereof) may be disposed on the light sheet substrate 18 with the LED strings 16a, 16b and 16c, in which case the driver circuit 14 (or the part thereof on the light sheet substrate) is integral with the light sheet 12. Furthermore, while the like-colored LEDs are disposed in strings 16a, 16b and 16c, this is not a limitation on the invention, and in other embodiments, other arrangements of separately controllable pluralities of LEDs may be employed.

The driver circuit 14 controls the color and intensity of the light output from the light sheet 12 by controlling the current provided to each LED string 16a, 16b and 16c. For this purpose, the driver circuit 14 includes a driver controller 20 (which may be a PID (proportional, integral and derivative) controller or a PD controller), a constant current correction circuit 22 and TRIACs (Triodes for Alternating Current) 24a, 24b and/or 24c that regulate the current flow to each respective LED strings 16a, 16b and/or 16c.

Power to activate the LED strings 16a, 16b and/or 16c is obtained from an external standard AC line voltage source 26, via the TRIACs 24a, 24b and/or 24c that regulate the current flow to each respective LED string 16a, 16b and/or 16c. The driver circuit 14 controls the current flow from the external AC source 26 to the LED string 16a, 16b and/or 16c by triggering the TRIACs 24a, 24b and/or 24c appropriately, in a manner similar to the way that incandescent dimmer switches operate, and in this way the driver circuit controls the intensity of the light output from the light sheet 12. The constant current correction circuit 22 receives a command signal that indicates the desired current (the “target current”) for each LED string 16a, 16b and/or 16c, and the constant current correction circuit provides trigger signals to the gates of the TRIACs 24a, 24b and/or 24c so that the TRIACs provide the desired current from the AC source 26 to the strings of LEDs. By providing TRIACs to modulate power derived directly from an external AC source, this invention eliminates the need for a high wattage DC power supply.

The constant current correction circuit 22 receives current feedback signals from a current feedback circuit 28 that indicates the actual currents through the LED strings 16a, 16b and 16c, and the constant current circuit can adjust the trigger signals so that the actual currents, as indicated by the feedback signals, more closely approaches the respective target currents. Each loop comprising a TRIAC 24a, 24b or 24c, an associated LED string 16a, 16b or 16c, the constant current correction circuit 22 and the current feedback circuit 28 is referred to herein as a first control loop.

As indicated above, the constant current correction circuit 22 provides trigger signals in response to a command signal provided by the driver controller 20. The driver controller 20 may adjust the command signals in response to signals from one or more various driver controller input devices. For example, a driver controller input device may be a light sensor. The light sheet module 10 includes three such light sensors 30a, 30b and/or 30c that indicate the level of light output from the LED strings 16a, 16b and/or 16c and provide indicative signals to the driver controller 20. The driver controller 20, upon receiving the signals from the light sensors 30a, 30b and/or 30c, may adjust the command signal to the constant current correction circuit 22 which, in turn, modulates the trigger signals to the TRIACS 24a, 24b and/or 24c so that the output from the light sheet 12 will more closely match a predetermined intensity. For example, a summing network in the driver controller 20 may take the difference between a predetermined target intensity programmed into the driver controller and the actual intensity (indicated by the light sensors 30a, 30b and/or 30c) and produce an error signal. The error signal indicates an adjustment to the duty cycle of the modulation technique employed by the constant current correction circuit 22 for triggering the TRIACS 24a, 24b and/or 24c, which may be pulse width modulation or pulse code modulation or the like. When more light is required, the driver controller 20 applies the error signal in producing a new command signal for the constant current correction circuit 22 so that the duty cycles for the TRIACs 24a, 24b and/or 24c are increased; when less light is needed, the duty cycles are reduced. The loop comprising the driver controller 20, the current correction circuit 18, TRIACs 24a, 24b and/or 24c, the associated LED strings 16a, 16b and/or 16c, and an input device for the driver controller 20 (such as the light sensors 30a, 30b and/or 30c) is referred to herein as a second control loop.

Another potential driver controller input device is an ambient light detector 32 that generates an ambient light signal that indicates the level of ambient light surrounding the light sheet module 10. In this case, the driver controller 20 may adjust the command signals in response to the ambient light signal. When the level of ambient light is high, the driver controller 20 may adjust the command signals to increase the intensity of the light sheet 12; when the level of ambient light is low, the driver controller 20 may adjust the command signals to decrease the intensity of the light sheet 12.

Still another potential driver controller input device is a temperature sensor 34 that generates a temperature signal that indicates the temperature of the lightsheet. In addition, the driver circuit 14 may include a memory circuit that contains signal adjustment data in a mapped data table 36 that indicates various desired current levels for the LED strings 16a, 16b and/or 16c at various temperatures. In this case, the driver controller 20 is configured to refer to the mapped data table 36 to relate the temperature signal to a desired current level for the LED strings 16a, 16b and/or 16c, and to adjust the command signals accordingly. The mapped table may be stored in E² (electronically erasable) memory devices or a similar non-volatile memory that is accessible by (optionally, incorporated into) the driver controller 20. Other various desired current levels may be associated with other criteria stored in the mapped data table 36, such as the age of the light sheet.

According to one aspect of the invention, the driver controller 20 can be configured to adjust the command signal to provide adaptive dimming of the backlight sheet in response to the nature of the image on the display. For this purpose, the driver controller 20 may receive a signal from the LCD display controller 38. Signals from the LCD display controller 38 may also be used by the driver controller 20 to synchronize the backlight illumination with the display image, to avoid flicker and motion blur.

A light sheet can be constructed from a plurality of light sheet strips or LED strings 16a, 16b and 16c in series/parallel arrangement. As a result, the light output can be maintained at acceptable operation levels when and if an LED in a LED strings 16a, 16b or 16c becomes shorted. As described further below, the light sheet is constructed using an ITO (indium-tin oxide) trace film that provides a path from the strings of LEDs to the driver circuit 14. The ITO traces are sized such that they will open when excessive current flows through them, like a series of fusible links. If an LED shorts, the ITO layer to that LED opens up and the remaining LEDs in that parallel chain will remain operating. This provides a type of redundancy path to extend the useful life of the backlight by correcting for LEDs that might become shorted during the normal lifespan of the BLU.

A light sheet can be configured with LED modules 12 such that the voltage drops of each string of LEDs allows for a direct connection to the external AC voltage source 26. The TRIACs 24a, 24b or 24c limit the AC cycle from the AC voltage source 26 to prevent burn-out of the strings of LEDs and to attain the color temperature of light as set by the constant current correction circuit 22 and the driver controller 20. In this way, the invention provides an LED backlight without the need for an expensive and bulky power supply circuit of the kind normally provided for television and computer monitor displays. Optionally, the TRIACS 24a, 24b and 24c limit the AC cycle supplied to the light sheet such that the TRIACS can dim the output of said light sheet while producing the correct color temperature of white light. While one embodiment of the invention comprises an ITO trace film layer, the invention is not limited in this regard as trace film layers made of other materials are known to those of ordinary skill in the art and may optionally be employed herein.

The driver circuit 14 and light sheet 12 as described herein are useful for the production of light sheet modules for backlights for LCD displays, backlit signs and other LED-illuminated devices.

As indicated above, the light sheet 12 includes LED strings 16a, 16b and 16c on a substrate. The light sheet 12 may be produced in various ways known in the art. For example, a sheet of base material such as polyethylene terephthalate (PET) or polyethylene naphthalate (PEN) that is part of the light sheet substrate 18 may have a conductive film (e.g., a copper film) cladded or otherwise bonded thereto and etched to form a first pattern of circuit traces (or “rails”) (not shown) on the substrate. The traces may or may not have conductive ink on them. Individually manufactured LED strings 16a, 16b, and 16c are disposed on the substrate and are electrically connected to respective circuit traces that serve as first electrodes (anodes or cathodes) providing a connection to the driver circuit 14 for the strings of LEDs. The light sheet substrate 18 may further a second pattern of circuit traces that preferably includes ITO (indium tin oxide), and the second pattern of circuit traces completes at least the first control loop by providing the strings of LEDs with a second connection to the driver circuit 14. While embodiments of the light sheet substrate comprising PET or PEN are disclosed herein, the invention is not limited in this regard as other materials suitable for a substrate are known to those of ordinary skill in the art and may optionally be employed herein.

In other embodiments, the light sheet may be produced as a flex circuit by providing a first flexible substrate with a first pattern of conductive leads thereon, disposing LEDs on the first pattern of leads, providing a second flexible substrate with a second pattern of conductive leads that corresponds to the positions of the LEDs on the first substrate, and applying the second substrate over the LEDs so that the leads thereon contact the LEDs. For example, a conductive foil (e.g., copper foil) is etched on a flex sheet substrate (which is typically made from a polyester material) to provide anode or cathode conductors for a pattern of LEDs to be applied thereto. A transparent top substrate that includes a patterned transparent conductor serves as the complementary cathode or anode, and preferably includes ITO connector traces for the LEDs. In one example of such a construction may be produced in a roll-to-roll method described in U.S. patent application Ser. No. 11/543,517 (Publication No. 2007/0026570) (“the '570 publication”), which is incorporated herein by reference, in its entirety, wherein the light active elements are LEDs that are assembled into lines or other addressable patterns directly on the substrate. The '570 publication discloses processes for making light sheets in which LEDs are disposed between a bottom substrate and top substrate. In one embodiment, the top substrate includes a transparent conductor comprising ITO provided as a continuous surface with which the LEDs communicate. In this way, the ITO provides current to the LEDs. See, e.g., the '570 publication, FIGS. 73-86; in particular, FIGS. 78 and 79, and paragraphs 325-340. Optionally, the ITO can be formed as a trace film that provides connections from light sheet module LEDs to driver circuits therefor, as described above. The ITO trace film can be formed from the continuous ITO layer by processes that employ wet etching; laser, ion beam or similar means for selectively burning out ITO to leave the desired traces, scribing with sharp device; or by patterned deposition using patterned electrical potential. As a result, the ITO trace film provides numerous resistance elements depicted as R₂ in FIG. 77 of the '570 publication. The effective resistance of the various ITO leads can be controlled by adjusting the bulk resistance of the ITO layer, e.g., by adjusting the thickness of the layer. Also, the effective resistance and current carrying capability can be controlled by controlling the configuration of the leads, e.g., by modifying their width. To facilitate control of the color output from the light sheet, LEDs of like color are addressable separately from LEDs of other colors, e.g., blue LEDs are controllable separately from red LEDs, etc., even if the commonly controllable LEDs are not disposed in strings.

In addition to preventing excess drain of current to a LED, the patterned ITO layer used in the place of the top sheet described in the '570 publication helps prevent cross-talk between the LED strings 16a, 16b and 16c when they are functioning and provides isolation between the various strings of LEDs in case of failure of one of the modules.

The ITO traces are preferably sized such that they will open when excessive current flows through them, like a series of fusible links. If an LED in a LED strings 16a, 16b or 16c shorts, the ITO trace to the shorted LED opens up and the remaining LEDs in parallel thereto will remain operating. This provides a type of redundancy path to extend the useful life of the backlight unit by correcting for LEDs that might become shorted during the normal life

The light sheet 12 may be produced in any convenient size by any of the foregoing methods, for example, in a 5 inch×10 inch size.

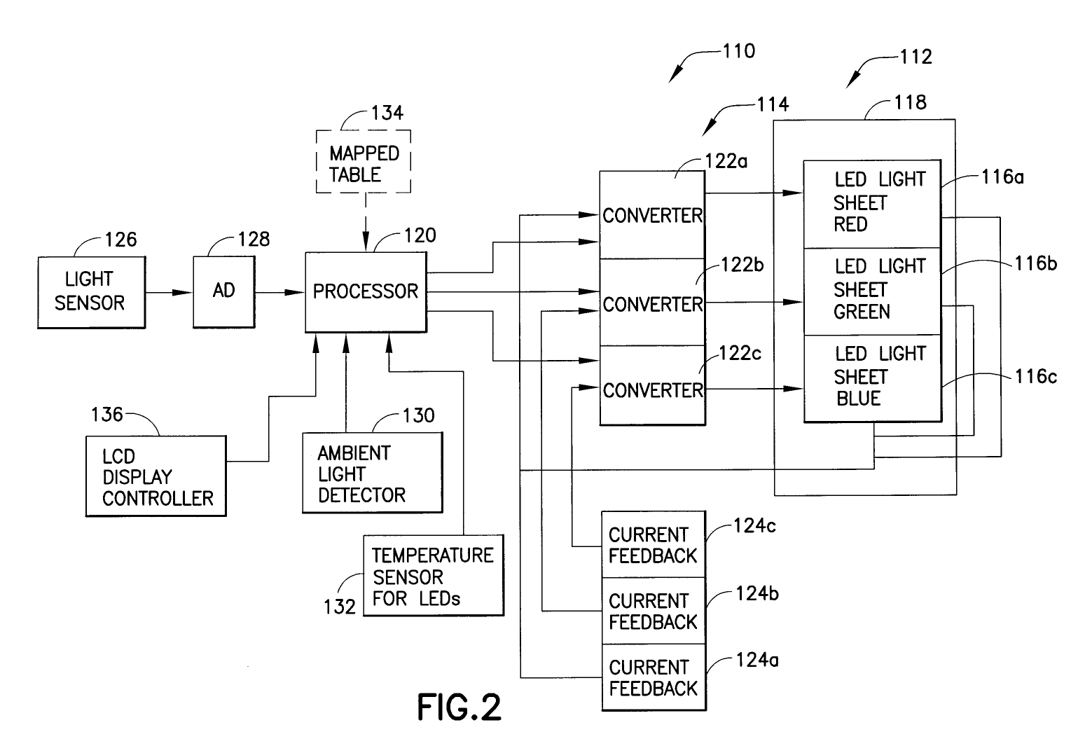

Another embodiment of the inventive light sheet module, indicated generally by the reference numeral 110 in FIG. 2, contains a light sheet 112 and a driver circuit 114 connected to the light sheet 112. The light sheet 112 includes strings (i.e., series connected) of red, green and blue light-emitting diodes (LEDs) 116a, 116b and 116c that are disposed on a light sheet substrate 118 as described further hereinbelow. Each LED string 116a, 116b and 116c comprises a plurality of like-colored red, green, or blue LEDs, and each LED string 116a, 116b and 116c is controllable separately from the others, i.e., the current through one LED string 116a, 116b or 116c is not dependent on current through another LED string. The driver circuit 114 is mounted on a driver circuit substrate (not shown) that is separate from the light sheet substrate 118, and the driver circuit is connected to the LED strings 116a, 116b and 116c in any convenient manner, e.g., by a modular connector (not shown). However, this is not a limitation on the invention, and in other embodiments, the driver circuit 114 (or some part thereof) may be disposed on the light sheet substrate 118 with the LED strings 116a, 116b and 116c, in which case the driver circuit 114 (or the part thereof on the light sheet substrate) is integral with the light sheet 112. Furthermore, while the like-colored LEDs are disposed in strings 116a, 116b and 116c, this is not a limitation on the invention, and in other embodiments, other arrangements of separately controllable pluralities of LEDs may be employed.

The driver circuit 114 controls the color and intensity of the light output from the light sheet 112 by controlling the current provided to each string of LEDs 116a, 116b and 112c. For this purpose, the driver circuit 114 includes a processor 120 and continuous mode inductor converters (CMICs) 122a, 122b and 122c connected the processor and to respective strings of LEDs 116a, 116b and 116c. The processor 120 generates a modulation signal for each CMIC 122a, 122b and 122c, and the CMICs provide current to respective strings of LEDs 116a, 116b and 116c at current levels indicated by the respective modulation signals. The processor 120 may generate the modulation signals using a time averaging technique, a pulse width modulation technique or a pulse code modulation technique or any other suitable technique.

The red, green, and blue strings of LEDs 116a, 116b and 116c together produce white light when their respective light outputs are mixed in the proper relative intensities, and other colors may be produced by varying the relative outputs of the strings of LEDs 116a, 116b and 116c. While the strings of LEDs 116a, 116b and 116c are shown as containing red, green and blue LEDs respectively, this is not a limitation on the invention, and in other embodiments, the light sheet 112 may contain more than, or fewer than, three colors of LEDs, and may contain LEDs of colors other than red, green and blue. Moreover, while strings of like-colored LEDs are disclosed, this is not a limitation on the invention, and any desired pattern of like-colored LEDs that is controllable by an associated CMIC may be employed.

The driver circuit 114 includes current feedback circuitry 124a, 124b and 124c in a loop that provides feedback signals to the CMICs 122a, 122b and 114c, the feedback signals indicating the actual current flowing through the respective strings of LEDs 116a, 116b and 116c. The CMICs 122a, 122b and 122c are configured to compare the actual current in their respective strings of LEDs 116a, 116b and 116c to the target current indicated by the respective modulation signals, and to adjust their outputs to bring the actual currents closer to the target currents. Each loop comprising a CMIC 122a, 122b or 122c, an associated string of LEDs 116a, 116b or 116c and current feedback circuitry 124a, 124b or 124c, is referred to herein as a first control loop.

The processor 120 may adjust one or more modulation signals in response to one or more various processor input devices. For example, a processor input device may include a light sensor 126 that generates an intensity signal that indicates the intensity of light output from the light sheet 112. The intensity signal may be provided to the processor 120 via an A/D converter 128. The processor 120, upon receiving the intensity signal, may adjust the modulation signals so that the output from the light sheet 112 will more closely match a desired or predetermined target intensity, e.g., by calculating corrections to the modulation signals required to attain the predetermined target intensity. For example, a summing network in the processor 120 may take the difference between the target intensity (indicated by the modulation signal) and the actual intensity (indicated by the light sensor 126) and produce an error signal. The error signal indicates an adjustment to the duty cycle of the modulation technique employed by the processor 120. When more light is required, the duty cycle is increased; when less light is needed, the duty cycle is reduced. The loop comprising the processor 120, a CMIC 122a, 122b or 122c, an associated string of LEDs 116a, 116b or 116c, and a processor input device such as the light sensor 126 (and A/D converter 128) is referred to herein as a second control loop.

Another possible processor input device is an ambient light detector 130. The ambient light detector 130 generates an ambient light signal that indicates the level of ambient light surrounding the backlighted display of which the light sheet 112 is a part. In such case, the processor 120 is configured to adjust the modulation signals in response to the output signal from the ambient light detector 130. When the level of ambient light is high, the processor 120 may adjust the modulation signals to increase the intensity of the light sheet 112; when the level of ambient light is low, the processor 120 may adjust the modulation signals to decrease the intensity of the light sheet 112.

Still another potential processor input device is a temperature sensor 132 that generates a temperature signal that indicates the temperature of the light sheet 112. In addition, the driver circuit 114 may include a memory circuit that contains data in a mapped data table 134 that indicates various desired current levels for the strings of LEDs 116a, 116b and 116c at various temperatures. In this case, the processor 120 is configured to refer to the mapped data table 134 to relate the temperature signal to a desired current level for the strings of LEDs 116a, 116b and 116c and to adjust the modulation signals accordingly. The mapped table may be stored in E² (electronically erasable) memory devices or a similar non-volatile memory that is accessible by (optionally, incorporated into) the processor 120. Other various desired current levels may be associated with other criteria stored in the mapped data table 134, such as the age of the light sheet.

Optionally, the processor 120 may be configured to adjust the modulation signals to provide adaptive dimming of the backlight sheet in response to the nature of the image on the display. For this purpose, the processor 120 may receive a signal from a processor input device that includes the liquid crystal display (LCD) controller 136. Signals from the LCD display controller 136 may also be used by the processor 120 to synchronize the backlight illumination with the display image, to avoid motion blur and flicker.

The LEDS in each string of LEDs 116a, 116b and 116c, and the strings of LEDs themselves, can be constructed in series/parallel arrangement. As a result, the light output can be maintained at acceptable operation levels when and if any one LED in a string, or when and if an entire string of LEDs 116a, 116b or 116c becomes shorted.

The driver circuit 114 and light sheet 112 as described herein are useful for the production of light sheet modules for backlights for LCD displays, backlit signs and other LED-illuminated devices.

As indicated above, the light sheet 112 includes strings of LEDs 116a, 116b and 116c on a substrate. The light sheet 112 may be produced in various ways known in the art. For example, a sheet of base material such as polyethylene terephthalate (PET) or polyethylene naphthalate (PEN) that is part of the light sheet substrate 118 may have a conductive film (e.g., a copper film) cladded or otherwise bonded thereto and etched to form a first pattern of circuit traces (or “rails”) (not shown) on the substrate. The traces may or may not have conductive ink on them. Individually manufactured strings of LEDs 116a, 116b, and 116c are disposed on the substrate and are electrically connected to respective circuit traces that serve as first electrodes (anodes or cathodes) providing a connection to the driver circuit 114 for the strings of LEDs. The light sheet substrate 118 may further a second pattern of circuit traces that preferably includes ITO (indium tin oxide), and the second pattern of circuit traces completes at least the first control loop by providing the strings of LEDs with a second connection to the driver circuit 114. While embodiments of the light sheet substrate comprising PET or PEN are disclosed herein, the invention is not limited in this regard as other materials suitable for a substrate are known to those of ordinary skill in the art and may optionally be employed herein.

In addition to preventing excess drain of current to a LED, the patterned ITO layer used in the place of the top sheet described in the '570 publication helps prevent cross-talk between the strings of LEDs 116a, 116b and 116c when they are functioning and provides isolation between the various strings of LEDs in case of failure of one of the modules.

The ITO traces are preferably sized such that they will open when excessive current flows through them, like a series of fusible links. If an LED in a string of LEDs 116a, 116b or 116c shorts, the ITO trace to the shorted LED opens up and the remaining LEDs in parallel thereto will remain operating. This provides a type of redundancy path to extend the useful life of the backlight unit by correcting for LEDs that might become shorted during the normal life

The light sheet 112 may be produced in any convenient size by any of the foregoing methods, for example, in a 5 inch×110 inch size.

The terms “first,” “second,” and the like, herein do not denote any order, quantity, or importance, but rather are used to distinguish one element from another. In addition, the terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the scope of this invention and of the appended claims.

What is claimed is:

1. A light sheet module comprising:
a light sheet having a separately controllable pluralities of LEDs on a substrate;
a driver circuit for the pluralities of LEDs, the driver circuit comprising a first control loop and a second control loop,
the first control loop comprising TRIACS for regulating current from an external AC power source to the LEDs in response to trigger signals, a constant current circuit for receiving a command signal indicative of a target current in the LEDs and for generating trigger signals to cause the TRIACs to provide current to the LEDs from the external AC power source, and current feedback circuitry for generating a current feedback signal indicative of the actual current in the LEDs, wherein the constant current circuit is responsive to the current feedback circuitry to adjust the trigger signals so that the actual current in the LEDs more closely approaches the target current; and
the second control loop comprising a driver controller configured to generate the command signal for the constant current circuit and being responsive to at least one input device for the Driver controller.

2. The light sheet module of claim 1, comprising a light sensor that provides a signal that indicates the intensity of the output of the LEDs, and wherein the driver controller is responsive to the light sensor and adjusts the command signal to adjust the output of the LEDs to a predetermined level.

3. The light sheet module of claim 1, comprising an ambient light detector configured to provide a signal that indicates the intensity of ambient light, and wherein the driver controller is responsive to the ambient light detector sensor and adjusts the modulation signal to adjust the output of the LED to a predetermined level in relation to the intensity of the ambient light.

4. The light sheet module of claim 1, comprising a temperature sensor for providing a signal that indicates the temperature of the LEDs and a mapped data table that contains data relating the LED temperature to desired LED current, and wherein the driver controller is responsive to the temperature sensor and to the mapped data table and adjusts the command signal to adjust the current to the LEDs to a predetermined level in relation to the temperature of the LEDs.

5. The light sheet module of claim 1, wherein said constant current circuit is configured to generate the trigger signals using a time averaging technique.

6. The light sheet module of claim 1, wherein said constant current circuit is configured to generate the trigger signals using a pulse width modulation technique or other modulation technique.

7. The light sheet module of claim 1, comprising a light sheet module comprising a plurality of LEDs and a driver circuit and conductive trace layer for each LED, wherein said processor determines a modulation signal for each of the LEDs to attain a predetermined brightness level of each of said light emitting diodes.

8. The light sheet module of claim 1, wherein said light sheet module comprises LEDs capable of producing white light together.

9. The light sheet module of claim 1, further comprising a conductive trace layer on the substrate for connecting the LED to the driver circuit.

10. The light sheet module of claim 1, wherein the conductive trace layer comprises indium tin oxide (ITO).

11. The light sheet module of claim 1, comprising separately controllable pluralities of LEDs arranged in separately controllable strings.

12. The light sheet of claim 1, comprising a light sensor that provides a signal that indicates the intensity of the output of the LEDs, and wherein the driver controller is responsive to the light sensor and adjusts the command signal to adjust the output of the LEDs to a predetermined level, said driver controller being configured to:
compare said output of said LEDs to a target output;
output a command signal to said first control loop that corresponds to the adjustment necessary to adjust the output to more closely approach the target output; and
control said TRIACS to supply alternating current (AC) at a specific current setting for said separately controllable pluralities of LEDs.

13. The light sheet of claim 10, wherein said TRIACS are capable of dimming the output of said light sheet while producing white light.

14. A method for powering a light sheet that comprises separately controllable pluralities of LEDs, the method comprising:
providing a TRIAC connected between an external AC power source and each separately controllable plurality of LEDs; and
providing trigger signals to each TRIAC to modulate the flow of current through each TRIAC to the respective separately controllable plurality of LEDs to attain a target current through, and resulting output from, each respective separately controllable plurality of LEDs.

15. The method of claim 14, comprising generating a current feedback signal indicative of the actual current in the LEDs and adjusting the trigger signals so that the actual current in the LEDs more closely approaches the target current.

16. The method of claim 14 comprising sensing the intensity of the output of a separately controllable plurality of LEDs, and adjusting the trigger signals so that the output of the separately controllable plurality of LEDs more closely approaches the target output.

17. The method of claim 14 comprising sensing the intensity of the ambient light around the separately controllable plurality of LEDs, and adjusting the trigger signals so that the output of the separately controllable plurality of LEDs attains a predetermined level in relation to the intensity of the ambient light.

18. The method of claim 14 comprising sensing the temperature of the separately controllable plurality of LEDs, and adjusting the trigger signals so that the current of the separately controllable plurality of LEDs more closely approaches a predetermined current that relates to the sensed temperature.
